(19) United States
(12) Patent Application Publication
(10) Pub. No.: US 2025/0300291 A1
(43) Pub. Date: Sep. 25, 2025

(54) STORAGE BATTERY PLACEMENT SYSTEM AND METHOD OF MOVING STORAGE BATTERY

(71) Applicant: Toyota Jidosha Kabushiki Kaisha, Toyota-shi (JP)

(72) Inventors: Takenori MIKAMI, Miyoshi-shi (JP); Kenji Baba, Seto-shi (JP); Kenji Takahashi, Toyota-shi (JP)

(73) Assignee: Toyota Jidosha Kabushiki Kaisha, Toyota-shi (JP)

(21) Appl. No.: 18/985,620

(22) Filed: Dec. 18, 2024

(30) Foreign Application Priority Data
Mar. 21, 2024 (JP) 2024-045599

(51) Int. Cl. H01M 50/244; H01M 50/209; H01M 50/262

(52) U.S. Cl. CPC H01M 50/244; H01M 50/209; H01M 50/262

(57) ABSTRACT

By supporting the storage battery with a metal plate, the support strength of the storage battery can be secured and the earthquake resistance can be secured. Further, a plate is provided on a lower surface of the storage battery, a plate is provided on an attachment that supports a plate provided in the storage battery in the storage battery storage equipment, and a plate in contact with the plate is provided on the storage battery placement table. By setting the lower surface of the plate and the upper surface of the plate in contact with each other, and the lower surface of the plate and the upper surface of the plate to be a so-called low friction surface, the storage battery can be stored or taken out in the storage battery storage equipment by a light-weight and simple mechanism.

### CROSS-REFERENCE TO RELATED APPLICATION

This application claims priority to Japanese Patent Application No. 2024-045599 filed on Mar. 21, 2024, incorporated herein by reference in its entirety.

### BACKGROUND

### 1. Technical Field

The present disclosure relates to storage battery placement systems and methods of moving a storage battery.

### 2. Description of Related Art

Japanese Unexamined Patent Application Publication No. 2002-226009 (JP 2022-226009 A) discloses a support structure (storage equipment) for storage batteries and transport equipment provided with a lifting unit configured to adjust its height with respect to the support structure according to a storage battery installation position. In this related art, the transport equipment moves on a dedicated rail and comes into contact with the storage equipment when installing or removing a storage battery in or from the storage equipment. After a storage battery placement plate with a storage battery placed thereon is lifted to a predetermined height by the lifting unit, the storage battery is placed on bearing units and is moved between the storage equipment and the transport equipment.

### SUMMARY

In the above related art, however, the transport equipment requires the lifting unit that adjusts its height with respect to the support structure according to a storage battery installation position. Therefore, the transport equipment becomes large and complicated. When the distance between the storage battery installation position in the storage equipment and the transport equipment is large, bearing units that fill the distance are required, which increases the weight of the storage equipment or transport equipment.

A mechanism that slides the bearing units between the storage equipment and the transport equipment is also required, which leads to a further increase in weight and complication of the structure. Since the bearing units do not contribute to the support strength for the storage batteries, the use of the bearing units may reduce earthquake resistance particularly in the case of a stationary power supply.

In view of the above, it is an object of the present disclosure to provide a storage battery placement system and a method of moving a storage battery that provide sufficient earthquake resistance and allow a storage battery to be loaded into or unloaded from storage battery storage equipment by a lightweight, simple mechanism.

A storage battery placement system of the disclosure of claim 1 includes: storage batteries;
storage battery storage equipment composed of a frame member configured to store the storage batteries in multiple tiers in a height direction, the storage battery storage equipment having a loading and unloading opening through which the storage battery is loaded into or unloaded from the storage battery storage equipment substantially in a horizontal direction; storage battery transport equipment including a storage battery placement table on which the storage battery is placeable, the storage battery placement table being movable toward the loading and unloading opening, and a position in the height direction of the storage battery placement table being settable with respect to the storage battery storage equipment;
a first plate member provided on a lower surface of the storage battery;
a second plate member provided on a beam portion extending substantially horizontally between pillar portions adjacent to each other in a depth direction of the frame member out of a plurality of pillar portions of the frame member, the second plate member being configured to support the first plate member from below; and
a third plate member provided on the storage battery placement table and configured to support the first plate member from below.

A lower surface of the first plate member, an upper surface of the second plate member, and an upper surface of the third plate member are set to be low friction surfaces having a smaller coefficient of friction than another surface of the first plate member, another surface of the second plate member, and another surface of the third plate member, respectively.

The storage battery placement system of the disclosure of claim 1 includes the storage batteries, the storage battery storage equipment, and the storage battery transport equipment. The storage battery storage equipment is composed of the frame member configured to store the storage batteries in multiple tiers in the height direction, and has the loading and unloading opening through which the storage battery is loaded into or unloaded from (stored in or removed from) the storage battery storage equipment substantially in the horizontal direction. The storage battery transport equipment includes the storage battery placement table on which the storage battery is placeable. The storage battery placement table is movable toward the loading and unloading opening, and the position in the height direction of the storage battery placement table is settable with respect to the storage battery storage equipment.

The first plate member is provided on the lower surface of the storage battery. In the storage battery storage equipment, the beam portion extends substantially horizontally between the pillar portions adjacent to each other in the depth direction of the frame member out of the pillar portions of the frame member. The second plate member configured to support the first plate member from below is provided on the beam portion. The third plate member configured to support the first plate member from below is provided on the storage battery placement table.

In the present disclosure, the lower surface of the first plate member, the upper surface of the second plate member, and the upper surface of the third plate member are set to be low friction surfaces having a smaller coefficient of friction than another surface of the first plate member, another surface of the second plate member, and another surface of the third plate member, respectively.

For example, when storing the storage battery in the frame member of the storage battery storage equipment, the position in the height direction of the storage battery placement table is first set with respect to the storage battery storage equipment. Next, the storage battery placed on the storage battery placement table of the storage battery transport equipment is moved toward the storage battery storage equipment with the low friction surface of the third plate member provided on the storage battery placement table and the low friction surface of the first plate member provided on the lower surface of the storage battery being in contact with each other. Since the storage battery is moved with the low friction surface of the third plate member on the storage battery placement table and the low friction surface of the first plate member on the storage battery being in contact with each other, the storage battery is smoothly moved with low friction from the storage battery placement table toward the storage battery storage equipment.

The second plate member on the beam portion provided in the frame member of the storage battery storage equipment supports the first plate member on the storage battery from below. Since the upper surface of the second plate member is a low friction surface, the storage battery is moved with the low friction surface of the first plate member on the storage battery and the low friction surface of the second plate member on the beam portion being in contact with each other. Therefore, the storage battery is smoothly moved with low friction and is stored in the storage battery storage equipment. The same applies to when the storage battery is removed from the storage battery storage equipment.

As described above, according to the present disclosure, the storage battery is supported by the plate member, which provides sufficient support strength for the storage battery and sufficient earthquake resistance.

In the present disclosure, the first plate member is provided on the lower surface of the storage battery, and the second plate member is provided on the beam portion that supports the first plate member provided on the storage battery in the storage battery storage equipment. The third plate member that the first plate member provided on the storage battery contacts is provided on the storage battery placement table. Since the contact surfaces of the plate members are set to be so-called low friction surfaces, the storage battery can be stored in or removed from the storage battery storage equipment by a lightweight, simple mechanism.

The low friction surface of the first plate member, the low friction surface of the second plate member, and the low friction surface of the third plate member may have different coefficients of friction.

According to a storage battery placement system of the disclosure of claim 2, in the storage battery placement system of the disclosure of claim 1,
the second plate member may include a guide portion that contacts both side surfaces of the storage battery in a width direction of the loading and unloading opening.

In the storage battery placement system of the disclosure of claim 2, the second plate member includes the guide portion, and both side surfaces of the storage battery in the width direction of the loading and unloading opening of the storage battery storage equipment contact the guide portion. The present disclosure can thus reduce horizontal displacement of the storage battery in the storage battery storage equipment and facilitate horizontal positioning of the storage battery.

According to a storage battery placement system of the disclosure of claim 3, the storage battery placement system of the disclosure of claim 1 may further include:
a plurality of holes provided in the height direction in a vertical column constituting the loading and unloading opening; and
a fixing tool that is engaged with the hole to fix the storage battery placement table at a predetermined position in the height direction.

In the storage battery placement system of the disclosure of claim 3, the holes are provided in the height direction in the vertical column constituting the loading and unloading opening of the storage battery storage equipment. The fixing tool is engaged with the hole to fix the storage battery placement table at the predetermined position in the height direction. For example, the position in the height direction of the storage battery placement table can be set with respect to the storage battery storage equipment by supporting the storage battery placement table via the fixing tool.

According to a storage battery placement system of the disclosure of claim 4, in the storage battery placement system of the disclosure of claim 1,
the storage battery placement table may include
an upper stage portion on which the third plate member is provided, and
a lower stage portion located below the upper stage portion and provided with an adjuster member that lifts or lowers the upper stage portion to finely adjust a position in the height direction of the upper stage portion with respect to the storage battery storage equipment.

In the storage battery placement system of the disclosure of claim 4, the storage battery placement table includes the upper stage portion and the lower stage portion. The third plate member is provided on the upper stage portion. The lower stage portion is located below the upper stage portion, and is provided with the adjuster member that lifts and lowers the upper stage portion. The position in the height direction of the upper stage portion can be finely adjusted with respect to the storage battery storage equipment by the adjuster member. This reduces a step between the storage battery storage equipment and the storage battery placement table and allows the storage battery to be moved more smoothly.

A method of moving a storage battery of the disclosure of claim 5 includes the following steps that are performed when storing the storage battery in the storage battery storage equipment in the storage battery placement system of the disclosure of any one of claims 1 to 4:
a height setting step of setting the position in the height direction of the storage battery placement table with respect to the storage battery storage equipment;
a first moving step of moving the storage battery toward the loading and unloading opening of the storage battery storage equipment with the low friction surface of the third plate member provided on the storage battery placement table and the low friction surface of the first plate member provided on the storage battery being in contact with each other; and
a storing step of moving the storage battery to a predetermined position in the storage battery storage equipment with the low friction surface of the first plate member provided on the storage battery and the low friction surface of the second plate member provided on the beam portion of the storage battery storage equipment being in contact with each other.

The method further includes the following steps that are performed when removing the storage battery from the storage battery storage equipment: the height setting step; a removing step of moving the storage battery toward the loading and unloading opening of the storage battery storage equipment with the low friction surface of the second plate member provided on the beam portion of the storage battery storage equipment and the low friction surface of the first plate member provided on the storage battery being in contact with each other; and
a second moving step of moving the storage battery onto the storage battery placement table with the low friction surface of the first plate member provided on the storage battery and the low friction surface of the third plate member provided on the storage battery placement table being in contact with each other.

The method of moving a storage battery of the disclosure of claim 5 includes the height setting step, the first moving step, and the storing step when storing the storage battery in the storage battery storage equipment. This method includes the height setting step, the removing step, and the second moving step when removing the storage battery from the storage battery storage equipment.

When storing the storage battery in the storage battery storage equipment, the position in the height direction of the storage battery placement table is first set with respect to the storage battery storage equipment in the height setting step. Next, in the first moving step, the storage battery is moved toward the loading and unloading opening of the storage battery storage equipment with the low friction surface of the third plate member provided on the storage battery placement table and the low friction surface of the first plate member provided on the storage battery being in contact with each other. Thereafter, in the storing step, the storage battery is moved to the predetermined position in the storage battery storage equipment with the low friction surface of the first plate member provided on the storage battery and the low friction surface of the second plate member provided on the beam portion of the storage battery storage equipment being in contact with each other.

As described above, the storage battery is moved from the storage battery placement table into the storage battery storage equipment with the low friction surface of the first plate member on the storage battery being in contact with the low friction surface of the third plate member on the storage battery placement table or the low friction surface of the second plate member on the beam portion of the storage battery storage equipment. Therefore, the storage battery is smoothly moved with low friction.

When removing the storage battery from the storage battery storage equipment, the position in the height direction of the storage battery placement table is first set with respect to the storage battery storage equipment in the height setting step. Next, in the removing step, the storage battery is moved toward the loading and unloading opening of the storage battery storage equipment with the low friction surface of the second plate member provided on the beam portion of the storage battery storage equipment and the low friction surface of the first plate member provided on the storage battery being in contact with each other. Thereafter, in the second moving step, the storage battery is moved onto the storage battery placement table with the low friction surface of the first plate member provided on the storage battery and the low friction surface of the third plate member provided on the storage battery placement table being in contact with each other.

As described above, the storage battery is moved from the storage battery storage equipment onto the storage battery placement table with the low friction surface of the first plate member on the storage battery being in contact with the low friction surface of the second plate member on the beam portion of the storage battery storage equipment or the low friction surface of the third plate member on the storage battery placement table. Therefore, the storage battery is smoothly moved with low friction.

As described above, according to the present disclosure, the storage battery is supported by the plate member, which provides sufficient support strength for the storage battery and sufficient earthquake resistance. The surface of the plate member that contacts the storage battery is set to be a so-called low friction surface. The storage battery can therefore be stored in or removed from the storage battery storage equipment by a lightweight, simple mechanism.

As described above, the storage battery placement system and the method of moving a storage battery according to the present disclosure provide sufficient earthquake resistance and allow a storage battery to be loaded into or unloaded from storage battery storage equipment by a lightweight, simple mechanism.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing storage battery storage equipment constituting a part of a storage battery placement system according to the present embodiment;

FIG. 2 is a schematic side sectional view showing the storage battery storage equipment and a storage battery placement table constituting the storage battery placement system according to the present embodiment;

FIG. 3 is a schematic front view showing the storage battery placement system according to the present embodiment;

FIG. 4 is a schematic perspective view showing storage battery storage equipment and a storage battery placement table showing a main part of the storage battery placement system according to the present embodiment;

FIG. 5 is a schematic perspective view showing a main part of the storage battery storage equipment and a storage battery showing a main part of the storage battery placement system according to an embodiment; and

FIG. 6 is a schematic perspective view showing a main part of the storage battery and the storage battery placement table showing a main part of the storage battery placement system according to the present embodiment.

### DETAILED DESCRIPTION OF EMBODIMENTS

Hereinafter, a storage battery placement system according to an embodiment of the present disclosure will be described with reference to the drawings.

### Configuration of Storage Battery Placement System

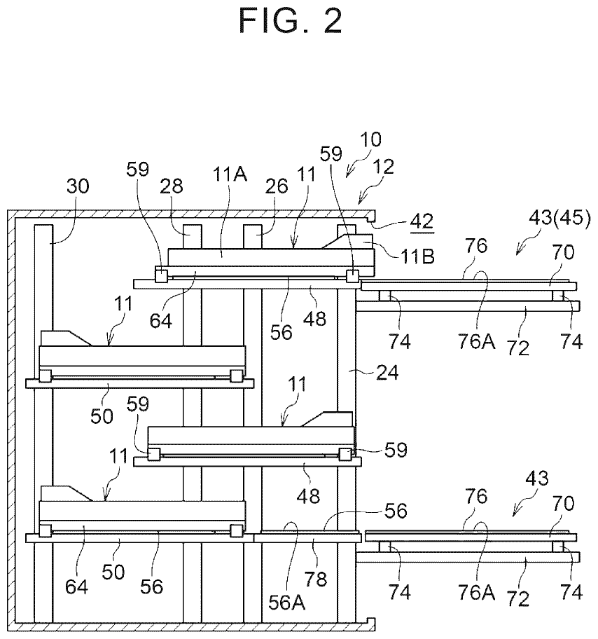

In the present embodiment, as shown in FIG. 2, the storage battery placement system includes a storage battery 11, storage battery storage equipment 10, and storage battery transport equipment 45.

### Storage Battery Storage Equipment

First, the storage battery storage equipment 10 of the storage battery placement system according to the embodiment of the present disclosure will be described.

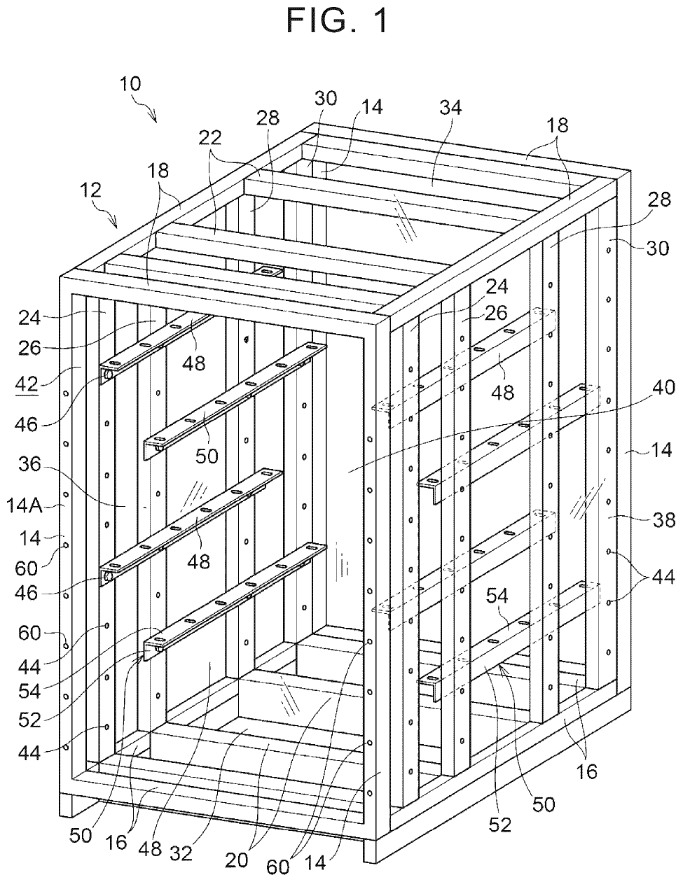

FIG. 1 shows the storage battery storage equipment 10 according to the present embodiment. The storage battery storage equipment 10 is a box body 12 having a rectangular box shape, and the skeleton of the storage battery storage equipment 10 includes pillar members 14 extending in the vertical direction of the box body 12, lower beam members 16 extending in the front-rear direction of the box body 12, and beam members such as upper beam members 18. Though these members are illustrated in a rectangular parallelepiped shape, for example, groove steel, H steel, or the like is used.

The pillar members 14 are each provided at a corner portion of the storage battery storage equipment 10. The lower ends of the pillar members 14 disposed adjacent to each other are connected by the lower beam members 16, and the upper ends of the pillar members 14 disposed adjacent to each other are connected by the upper beam members 18.

Further, a plurality of lower beam members 20 extends in the width direction of the storage battery storage equipment 10 between a pair of lower beam members 16 respectively provided along the depth direction of the storage battery storage equipment 10 and facing each other. In addition, a plurality of upper beam members 22 extends in the width direction of the storage battery storage equipment 10 between a pair of upper beam members 18 respectively provided along the depth direction of the storage battery storage equipment 10 and facing each other.

Further, in the present embodiment, for example, four pillar members 24, 26, 28, and 30 are erected between the pillar members 14 respectively disposed in front and rear directions in the depth direction of the storage battery storage equipment 10. In the present embodiment, the storage battery storage equipment 10 includes a lower wall portion 32, an upper wall portion 34, a pair of side wall portions 36 and 38, and a back wall portion 40. A loading and unloading opening 42 through which the storage battery 11 (see FIG. 2) can be loaded to and unloaded from the storage battery storage equipment 10 is provided on the front side of the storage battery storage equipment 10.

An opening and closing door (not shown) is provided at the loading and unloading opening 42, and the inside of the storage battery storage equipment 10 can be opened and closed by the opening/closing door. In the storage battery storage equipment 10, with the loading and unloading opening 42 opened, as shown in FIG. 2, the storage battery 11 is loaded into and unloaded from the storage battery storage equipment 10 substantially in the horizontal direction via the storage battery placement table 43 constituting part of the storage battery transport equipment 45 through the loading and unloading opening 42.

Note that, in FIG. 1, the lower wall portion 32, the upper wall portion 34, the pair of side wall portions 36 and 38, and the back wall portion 40 are shown as a transparent plate member so that the configuration in the storage battery storage equipment 10 can be seen, but these wall materials need not be transparent. Further, since the storage battery storage equipment 10 is closed by the wall material, even if the storage battery storage equipment 10 is disposed outdoors, it is possible to suppress the influence on wind and rain in the storage battery storage equipment 10. Depending on the location of the storage battery storage equipment 10, the wall material is not necessarily required.

Here, a plurality of fixing holes 44 are provided along the height direction on the inner surface side of each of the pillar members 24, 26, 28, and 30, and fasteners 46 such as bolts can be fixed via the fixing holes 44. Attachments 48 and 50 can be fixed to the pillar members 24, 26, 28, and 30.

The attachments 48 and 50 are formed to be shorter than the dimension of the storage battery storage equipment 10 in the depth direction, for example. The attachment 48 is fixed so as to extend substantially in the horizontal direction with respect to the pillar members 26, 28, and 30. On the other hand, the attachment 50 is fixed in a state of being extended substantially in the horizontal direction with respect to the pillar members 24, 26, and 28. That is, in the present embodiment, as shown in FIG. 2, the attachment 48 and the attachment 50 are arranged in a state of being shifted in the front-rear direction in the depth direction of the storage battery storage equipment 10.

In the present embodiment, four pillar members 24, 26, 28, and 30 are erected between the pillar members 14 respectively disposed in the front-rear direction in the depth direction of the storage battery storage equipment 10, but one pillar member may be provided between the pillar members 14.

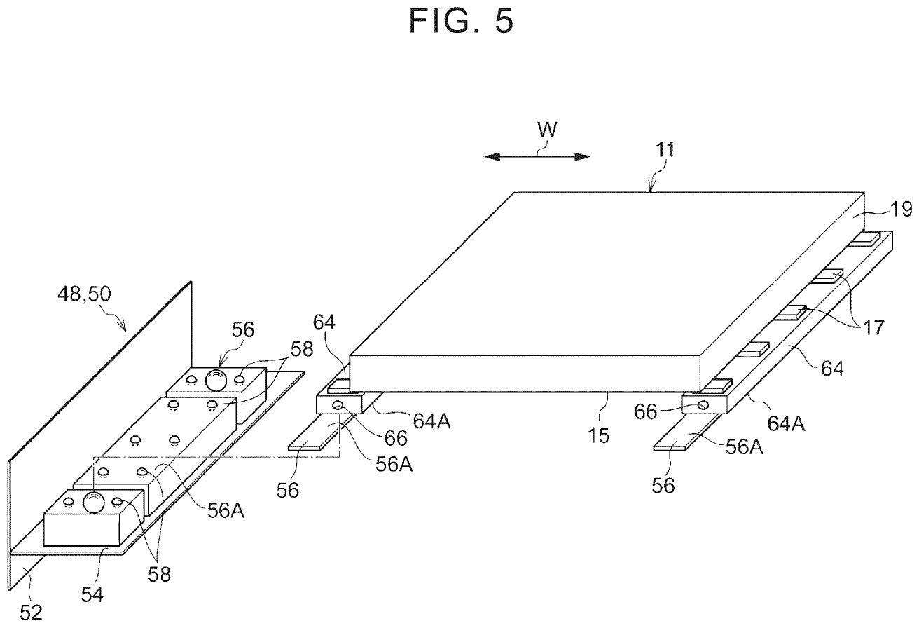

As shown in FIG. 1, the attachments 48 and 50 are formed, for example, of a steel plate in a substantially inverted L-shape and include two fixing pieces 52 and 54 orthogonal to each other. One of the fixing pieces 52 is fixable to the pillar members 24, 26, 28, and 30, and the other fixing piece 54 is fixable to the storage battery 11. Note that the shapes of the attachments 48 and 50 may be substantially T-shaped as shown in FIG. 5.

Further, in the present embodiment, as shown in FIG. 1, the attachment 48 and the attachment 50 are arranged in a state of being displaced in the front-rear direction in the depth direction of the storage battery storage equipment 10. That is, the attachment 48 is disposed on the front side in the storage battery storage equipment 10, and the attachment 50 is disposed on the back side in the storage battery storage equipment 10.

Here, in the present embodiment, as shown in FIG. 5, for example, a metal plate (second plate member) 56 is fixed to the fixing piece 54 side of the attachments 48 and 50. The upper surface 56A of the plate 56 is set to be a low friction surface having a friction coefficient smaller than that of the upper surface of the fixing piece 54.

For example, the upper surface 56A of the plate 56 formed of stainless steel or the like may be subjected to Teflon processing to form a low friction surface on the upper surface 56A, or the plate 56 may be formed of a material having a low friction coefficient, such as a carbon plate. In addition, a low friction surface may be formed on the upper surface 56A of the plate 56 by projecting a material (for example, spherical carbon 58 or the like) having a low friction coefficient from the upper surface 56A. In this case, the contact area can be reduced, and the friction coefficient on the upper surface 56A of the plate 56 can be further reduced.

Further, in the present embodiment, the attachments 48 and 50 are provided with guide portions 59 (see FIG. 2) that can be brought into contact with both side surfaces 19 of the storage battery 11, and the storage battery 11 housed in the storage battery storage equipment 10 is aligned in the horizontal direction.

Further, as shown in FIG. 1, a plurality of fixing holes (hole portions) 60 are provided on the front 14A of the pillar member (vertical pillar) 14 provided with the loading and unloading opening 42 in the storage battery storage equipment 10 in accordance with the height positions of the attachments 48 and 50. Although not shown, a fastener such as a bolt can be fixed to the fixing hole 60 (described later).

### Storage Battery

Next, the storage battery 11 of the storage battery placement system according to the embodiment of the present disclosure will be described.

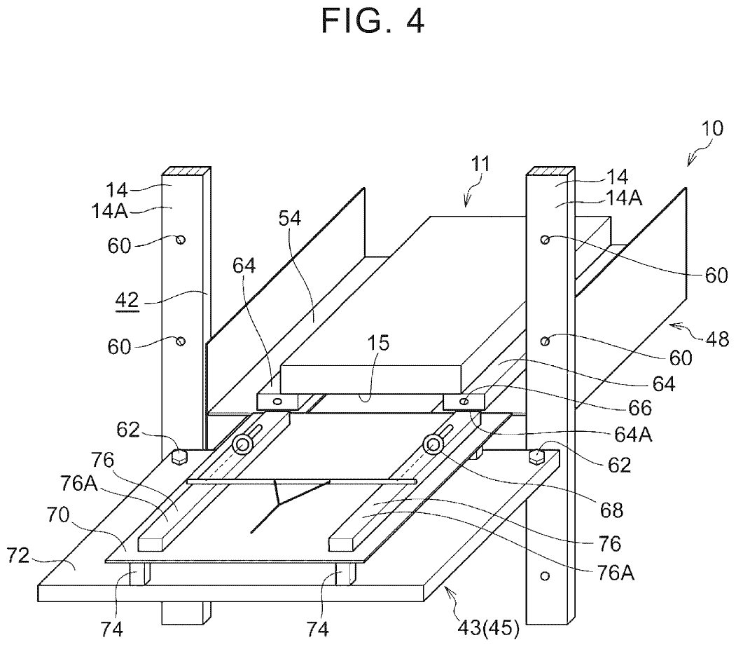

As shown in FIG. 2, the storage battery 11 accommodated in the storage battery storage equipment 10 has a substantially rectangular plate shape in a plan view, and a thick portion 11B formed thicker in the height direction than the general portion 11A is provided at one end portion in the longitudinal direction of the storage battery 11. The shape of the storage battery 11 is not limited thereto. For example, as shown in FIGS. 4 and 5, the storage battery 11 may have a substantially rectangular plate shape in a plan view.

In the present embodiment, a plate (first plate member) 64 is fixed to the lower surface 15 side of the storage battery 11. For example, as shown in FIG. 5, a bracket 17 for mounting on a rocker side of a vehicle (not shown) is provided at both ends of the storage battery 11 in the width direction (arrow W direction), and a plate 64 is bolted (fixed) to the bracket 17. Note that, at a portion where the bolt is fastened, a recess is formed in the plate 64 so that the head portion of the bolt does not protrude from the lower surface 64A of the plate 64.

The lower surface 64A of the plate 64 is set to be a low friction surface having a friction coefficient smaller than that of the lower surface 15 of the storage battery 11.

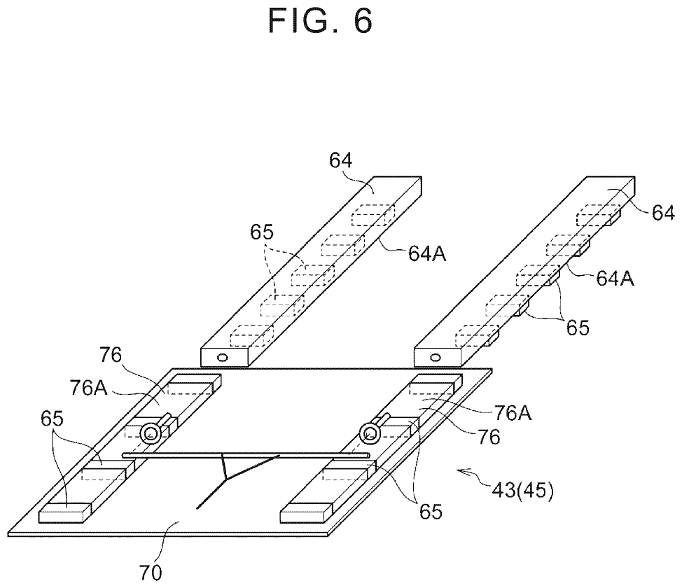

Like the plate 56, for example, the plate 64 forms a low friction surface on the lower surface 64A by performing Teflon processing on the lower surface 64A of the plate 64 formed of stainless steel or the like. The plate 64 may be formed of a material having a low coefficient of friction, such as a carbon plate, on the plate 64 itself. Further, a low friction surface may be formed on the lower surface 64A by projecting a material having a low friction coefficient from the lower surface 64A of the plate 64. Further, as shown in FIG. 6, the contact area may be reduced by providing a plurality of carbon plates 65 at predetermined intervals along the longitudinal direction of the plate 64.

In the plate 64, an engagement hole 66 is formed in an end surface in the longitudinal direction. For example, an eyebolt 68 (a U-shaped hook or the like in addition thereto) is engageable with the engagement hole 66. When the plate 64 is pulled out by a lever block (registered trademark) (not shown) or the like via the eyebolt 68, the storage battery 11 in the storage battery storage equipment 10 can be moved toward the storage battery placement table 43.

### Storage Battery Transport Equipment

Further, the storage battery transport equipment 45 of the storage battery placement system according to the embodiment of the present disclosure will be described.

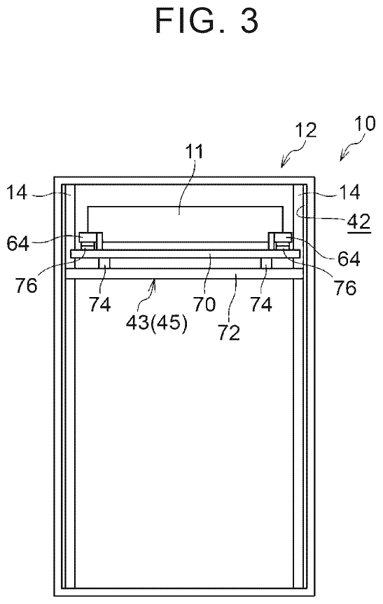

As illustrated in FIGS. 2 to 4, the storage battery transport equipment 45 includes a storage battery placement table 43. The storage battery placement table 43 includes a upper stage portion 70 in the form of a flat plate and a lower stage portion 72 in the form of a flat plate, and an upper stage portion 70 is disposed above the lower stage portion 72, and the storage battery 11 is disposed in the upper stage portion 70. An adjuster member 74 is provided between the upper stage portion 70 and the lower stage portion 72. The adjuster member 74 is provided in the lower stage portion 72, and lifts and lowers the upper stage portion 70 with respect to the lower stage portion 72.

The position of the storage battery placement table 43 in the height direction with respect to the storage battery storage equipment 10 is set by a crane, a forklift, or the like (not shown). As described above, in the storage battery storage equipment 10, a plurality of fixing holes 60 are provided on the front 14A of the pillar member 14, and fasteners such as bolts are fixed to the fixing holes 60.

In the present embodiment, for example, a bracket (not shown) that supports the front end portion of the lower stage portion 72 of the storage battery placement table 43 is fixed to the pillar member 14 via the fastener and the fixing hole 60. Then, the front end portion of the storage battery placement table 43 is fixed to the bracket via a fastener (fixing tool) 62 provided in the lower stage portion 72. That is, the front end portion of the storage battery placement table 43 is fixed to the pillar member 14 via the bracket, and the position of the storage battery placement table 43 in the height direction is set with respect to the storage battery storage equipment 10.

On the other hand, the lower stage portion 72 is provided with an adjuster member 74. The adjuster member 74 includes, for example, a lead screw and a nut screwed to the lead screw and arranged vertically, and the upper stage portion 70 is supported by the nut arranged on the upper side, although not shown. Then, the nut disposed on the upper side is moved in the up-down direction along the thread groove of the lead screw by the rotation of the nut disposed on the lower side. The upper stage portion 70 can be lifted and lowered with respect to the lower stage portion 72 through the nut.

Here, a pair of metal plates (third plate members) 76 are fixed to the upper stage portion 70 along the direction in which the storage battery 11 enters and leaves. The upper surface 76A of the plate 76 is set to be a low friction surface having a friction coefficient smaller than that of the upper surface of the upper stage portion 70.

For example, similarly to the plates 56 and 64, the plate 76 forms a low friction surface on the upper surface 76A by performing Teflon processing on the upper surface 76A of the plate 76 formed of stainless steel or the like. The plate 76 may be formed of a material having a low coefficient of friction, such as a carbon plate, on the plate 76 itself. Further, a low friction surface may be formed on the upper surface 76A of the plate 76 by projecting a material having a low friction coefficient from the upper surface 76A. Like the plate 64 shown in FIG. 6, a plurality of carbon plates 65 may be provided at predetermined intervals along the longitudinal direction with respect to the plate 76. The method of setting the low friction surfaces of the plates 56, 64, and 76 may be different from each other.

### Operation and Effect of Storage Battery Placement System

Next, the operation and effects of the storage battery placement system according to the embodiment of the present disclosure will be described.

In the present embodiment, the storage battery 11 illustrated in FIGS. 2 to 5 includes a height setting step, a first moving step, and a storing step when being stored in the storage battery storage equipment 10. The removal of the storage battery 11 from the storage battery storage equipment 10 includes a height setting step, a removing step, and a second moving step.

### Storing Storage Battery

First, a case where the storage battery 11 is stored in the storage battery storage equipment 10 will be described.

As described above, when the storage battery 11 is stored in the storage battery storage equipment 10, it includes a height setting step, a first moving step, and a storing step.

In the present embodiment, in the height setting step, the position of the storage battery placement table 43 in the height direction is set with respect to the storage battery storage equipment 10. For example, a bracket (not shown) is fixed to a predetermined position of the pillar member 14 of the storage battery storage equipment 10. Then, the storage battery 11 is placed on the storage battery placement table 43 by a crane, a forklift, or the like at a predetermined position in the storage battery storage equipment 10, and the front end portion of the lower stage portion 72 of the storage battery placement table 43 is supported by a bracket. In this state, the storage battery placement table 43 is roughly positioned in the height direction with respect to the storage battery storage equipment 10.

Next, in the height adjustment step, fine adjustment in the height direction of the upper stage portion 70 is performed by the adjuster member 74 provided in the lower stage portion 72 of the storage battery placement table 43. In the plate 76 provided in the upper stage portion 70, the upper surface 76A having low friction is substantially flush with the upper surface 56A having low friction in the plate 56 provided on the fixing piece 54 side of the attachment 48 of the storage battery storage equipment 10. In this state, the storage battery 11 placed on the storage battery placement table 43 is stored in the storage battery storage equipment 10.

In the first moving step, the plate 64 is fixed to the lower surface 15 side of the storage battery 11. The storage battery 11 is moved toward the loading and unloading opening 42 of the storage battery storage equipment 10 while the lower surface 64A of the plate 64, which is low friction, contacts the upper surface 76A of the plate 76 provided on the upper stage portion 70 of the storage battery placement table 43.

Then, when the storage battery 11 moves from the storage battery placement table 43 into the storage battery storage equipment 10, in the storing step, the lower surface 64A of the plate 64 provided on the storage battery 11 side contacts the upper surface 56A of the plate 56 provided on the attachment 48 side of the storage battery storage equipment 10. In this state, the storage battery 11 is moved to a predetermined position in the storage battery storage equipment 10.

As described above, in the present embodiment, the lower surface 64A of the plate 64 of the storage battery 11 is contacted with the upper surface 76A of the plate 76 of the storage battery placement table 43 or the upper surface 56A of the plate 56 of the attachment 48 of the storage battery storage equipment 10. In this state, the storage battery 11 is moved from the storage battery placement table 43 into the storage battery storage equipment 10. In the present embodiment, since the lower surface 64A of the plate 64, the upper surface 76A of the plate 76, and the upper surface 56A of the plate 56 are so-called low friction surfaces, the storage battery 11 smoothly moves from the storage battery placement table 43 toward the storage battery storage equipment 10 in a low friction condition.

### Removing Storage Battery

Next, the case where the storage battery 11 is taken out from the storage battery storage equipment 10 will be described.

As described above, taking out the storage battery 11 from the storage battery storage equipment 10 includes a height setting step, a removing step, and a second moving step.

In the present embodiment, in the height setting step, the position of the storage battery placement table 43 in the height direction is set with respect to the storage battery storage equipment 10. In the height adjustment step, fine adjustment in the height direction of the upper stage portion 70 is performed by the adjuster member 74 provided in the lower stage portion 72 of the storage battery placement table 43.

Then, in the removing step, the upper surface 56A of the plate 56 provided on the attachment 48 of the storage battery storage equipment 10 and the lower surface 64A of the plate 64 provided on the storage battery 11 are brought into contact with each other. In this state, the storage battery 11 is moved to the loading and unloading opening 42 side of the storage battery storage equipment 10.

Next, in the second moving step, the storage battery 11 is moved onto the storage battery placement table 43 while the lower surface 64A of the plate 64 provided in the storage battery 11 and the upper surface 76A of the plate 76 provided in the storage battery placement table 43 are brought into contact with each other.

As described above, the storage battery 11 is moved from the inside of the storage battery storage equipment 10 to the storage battery placement table 43 with the lower surface 64A of the plate 64 of the storage battery 11 contacting the upper surface 56A of the plate 56 of the attachment 48 of the storage battery storage equipment 10 or the upper surface 76A of the plate 76 of the storage battery placement table 43. Therefore, the storage battery 11 moves smoothly with low friction.

As described above, in the present embodiment, the storage battery 11 is supported by the plate 64, so that the surface can be supported, and the support strength of the storage battery 11 can be secured and the earthquake resistance can be secured.

Further, in the present embodiment, the plate 64 is provided on the lower surface 15 of the storage battery 11, and the plate 56 is provided on the attachments 48 and 50 that support the plate 64 provided in the storage battery 11 in the storage battery storage equipment 10. At the same time, a plate 76 in which the plate 64 comes into contact with the storage battery placement table 43 is provided.

In the present embodiment, the lower surface 64A of the plate 64 contacting each other, the upper surface 56A of the plate 56, the lower surface 64A of the plate 64, and the upper surface 76A of the plate 76 are set to be so-called low friction surfaces. As a result, in the present embodiment, the storage battery 11 can be stored in or taken out of the storage battery storage equipment 10 by a lightweight and simple mechanism.

Further, for example, although not shown, the storage battery placement table 43 can have a simple configuration in the present embodiment as compared with a case where the transport equipment for transporting the storage battery 11 is provided with a lifting unit and a dedicated rail, and the transport equipment is caused to move on the rail. In addition, it is possible to increase the degree of freedom in the arrangement location of the storage battery storage equipment 10.

Further, in the present embodiment, the plate 56 includes a guide portion 59 that abuts on both side surfaces 19 of the storage battery 11 along the width direction of the loading and unloading opening 42 of the storage battery storage equipment 10. With the guide portion 59, in the present embodiment, it is possible to suppress the deviation of the storage battery 11 in the horizontal direction in the storage battery storage equipment 10 and to easily perform the horizontal alignment of the storage battery 11.

Further, in the present embodiment, a plurality of fixing holes 60 are provided along the height in the front 14A of the pillar member 14 constituting the loading and unloading opening 42 of the storage battery storage equipment 10. A bracket (not shown) is fixed to the fixing hole 60, and the storage battery placement table 43 can be fixed at a predetermined position in the height direction via the bracket.

Furthermore, in the present embodiment, the storage battery placement table 43 includes an upper stage portion 70 and a lower stage portion 72, and a plate 76 is provided in the upper stage portion 70. On the other hand, the lower stage portion 72 is provided on the lower side of the upper stage portion 70, and an adjuster member 74 for lifting or lowering the upper stage portion 70 is provided, and the position of the upper stage portion 70 in the height direction with respect to the storage battery storage equipment 10 can be finely adjusted by the adjuster member 74. Accordingly, it is possible to eliminate a step between the storage battery storage equipment 10 and the storage battery placement table 43 and to further smoothly move the storage battery 11.

Incidentally, in the present embodiment, as shown in FIG. 2, the attachment 48 and the attachment 50 are arranged in a state of being shifted forward and backward in the depth direction of the storage battery storage equipment 10. In the above embodiment, storage or removal of the storage battery 11 from the attachment 48 side of the storage battery storage equipment 10 is described. The attachment 48 is disposed on the loading and unloading opening 42 side of the storage battery storage equipment 10, and the attachment 48 and the storage battery placement table 43 can be disposed in a state of being close to each other.

On the other hand, since the attachment 50 is disposed on the back side of the storage battery storage equipment 10, the attachment 50 and the storage battery placement table 43 are disposed in a separate state. Therefore, when the storage battery 11 is accommodated in or taken out of the attachment 50, the extension rail 78 is connected between the attachment 50 and the storage battery placement table 43.

For example, a bracket (not shown) is fixed to the pillar members 24 and 26, and the extension rail 78 is supported via the bracket. Then, one end side of the extension rail 78 is engaged with one end side of the attachment 50 by a connection hook or the like, and the other end side of the extension rail 78 is engaged with one end side of the upper stage portion 70 of the storage battery placement table 43. Further, the extension rail 78 is provided with a plate 56 provided on the attachment 50, and the storage battery 11 can be smoothly moved between the storage battery storage equipment 10 and the storage battery placement table 43 via the extension rail 78.

Note that the storage battery 11 may be a storage battery used in other applications than the vehicle storage battery, or may be a reusable storage battery.

Although an embodiment of the present disclosure has been described above, the present disclosure is not limited to such an embodiment, and combinations of the embodiment and various modifications may be used as appropriate in the present disclosure. Needless to say, the present disclosure can be implemented in various forms without departing from the scope of the present disclosure.

### Additional Remarks

The vehicle skeleton member according to the present disclosure may be formed by appropriately combining the following configurations.

### Configuration 1

A storage battery placement system includes:
storage batteries;
storage battery storage equipment composed of a frame member configured to store the storage batteries in multiple tiers in a height direction, the storage battery storage equipment having a loading and unloading opening through which the storage battery is loaded and unloaded substantially in a horizontal direction;
storage battery transport equipment including a storage battery placement table on which the storage battery is placeable, the storage battery placement table being movable toward the loading and unloading opening, and a position in the height direction of the storage battery placement table being settable with respect to the storage battery storage equipment;
a first plate member provided on a lower surface of the storage battery;
a second plate member provided on a beam portion extending substantially horizontally between pillar portions adjacent to each other in a depth direction of the frame member out of a plurality of pillar portions of the frame member, the second plate member being configured to support the first plate member from below; and
a third plate member provided on the storage battery placement table and configured to support the first plate member from below.

The lower surface of the first plate member, an upper surface of the second plate member, and an upper surface of the third plate member are set to be low friction surfaces having a smaller coefficient of friction than the lower surface of the storage battery, an upper surface of the beam portion, and an upper surface of the storage battery placement table, respectively.

### Configuration 2

The second plate member includes a guide portion that abuts both side surfaces of the storage battery along the width direction of the loading and unloading opening.

### Configuration 3

The storage battery placement system further includes: a plurality of holes provided in the height direction in a vertical pillar constituting the loading and unloading opening; and
a fixing tool that is engaged with the hole portion to fix the storage battery placement table at a predetermined position in the height direction.

### Configuration 4

The storage battery placement table includes
an upper stage portion on which the third plate member is provided, and
a lower stage portion located below the upper stage portion and provided with an adjuster member that lifts or lowers the upper stage portion to finely adjust a position in the height direction of the upper stage portion with respect to the storage battery storage equipment.

### Configuration 5

A method for moving a storage battery includes the following steps that are performed when storing the storage battery in the storage battery storage equipment in the storage battery placement system according to any one of claims 1 to 4,
a height setting step of setting the position in the height direction of the storage battery placement table with respect to the storage battery storage equipment;
a first moving step of moving the storage battery toward the loading and unloading opening of the storage battery storage equipment with the low friction surface of the third plate member provided on the storage battery placement table and the low friction surface of the first plate member provided on the storage battery being in contact with each other; and
a storing step of moving the storage battery to a predetermined position in the storage battery storage equipment with the low friction surface of the first plate member provided on the storage battery and the low friction surface of the second plate member provided on the beam portion of the storage battery storage equipment being in contact with each other.

The method further includes the following steps that are performed when removing the storage battery from the storage battery storage equipment: the height setting step;
a removing step of moving the storage battery toward the loading and unloading opening of the storage battery storage equipment with the low friction surface of the second plate member provided on the beam portion of the storage battery storage equipment and the low friction surface of the first plate member provided on the storage battery being in contact with each other; and
a second moving step of moving the storage battery onto the storage battery placement table with the low friction surface of the first plate member provided on the storage battery and the low friction surface of the third plate member provided on the storage battery placement table being in contact with each other.

What is claimed is:

1. A storage battery placement system, comprising:
storage batteries;
storage battery storage equipment composed of a frame member configured to store the storage batteries in multiple tiers in a height direction, the storage battery storage equipment having a loading and unloading opening through which the storage battery is loaded into or unloaded from the storage battery storage equipment substantially in a horizontal direction;
storage battery transport equipment including a storage battery placement table on which the storage battery is placeable, the storage battery placement table being movable toward the loading and unloading opening, and a position in the height direction of the storage battery placement table being settable with respect to the storage battery storage equipment;
a first plate member provided on a lower surface of the storage battery;
a second plate member provided on a beam portion extending substantially horizontally between pillar portions adjacent to each other in a depth direction of the frame member out of a plurality of pillar portions of the frame member, the second plate member being configured to support the first plate member from below; and
a third plate member provided on the storage battery placement table and configured to support the first plate member from below, wherein a lower surface of the first plate member, an upper surface of the second plate member, and an upper surface of the third plate member are set to be low friction surfaces having a smaller coefficient of friction than the lower surface of the storage battery, an upper surface of the beam portion, and an upper surface of the storage battery placement table, respectively.

2. The storage battery placement system according to claim 1, wherein the second plate member includes a guide portion that contacts both side surfaces of the storage battery in a width direction of the loading and unloading opening.

3. The storage battery placement system according to claim 1, further comprising:
a plurality of holes provided in the height direction in a vertical column constituting the loading and unloading opening; and
a fixing tool that is engaged with the hole to fix the storage battery placement table at a predetermined position in the height direction.

4. The storage battery placement system according to claim 1, wherein the storage battery placement table includes
an upper stage portion on which the third plate member is provided, and
a lower stage portion located below the upper stage portion and provided with an adjuster member that lifts or lowers the upper stage portion to finely adjust a position in the height direction of the upper stage portion with respect to the storage battery storage equipment.

5. A method of moving a storage battery, the method comprising the following steps that are performed when storing the storage battery in the storage battery storage equipment in the storage battery placement system according to claim 1:
a height setting step of setting the position in the height direction of the storage battery placement table with respect to the storage battery storage equipment;
a first moving step of moving the storage battery toward the loading and unloading opening of the storage battery storage equipment with the low friction surface of the third plate member provided on the storage battery placement table and the low friction surface of the first plate member provided on the storage battery being in contact with each other; and
a storing step of moving the storage battery to a predetermined position in the storage battery storage equipment with the low friction surface of the first plate member provided on the storage battery and the low friction surface of the second plate member provided on the beam portion of the storage battery storage equipment being in contact with each other, and the method further comprising the following steps that are performed when removing the storage battery from the storage battery storage equipment:
the height setting step;
a removing step of moving the storage battery toward the loading and unloading opening of the storage battery storage equipment with the low friction surface of the second plate member provided on the beam portion of the storage battery storage equipment and the low friction surface of the first plate member provided on the storage battery being in contact with each other; and
a second moving step of moving the storage battery onto the storage battery placement table with the low friction surface of the first plate member provided on the storage battery and the low friction surface of the third plate member provided on the storage battery placement table being in contact with each other.
